(19) United States
(12) Patent Application Publication
(10) Pub. No.: US 2009/0182637 A1
(43) Pub. Date: Jul. 16, 2009

(54) METHOD OF REFERRAL MARKETING

(76) Inventor: Lee Roberts, Noble, OK (US)

Correspondence Address: ADVANTIA LAW GROUP, 9035 SOUTH 1300 EAST, SUITE 200, SANDY, UT, 84094, US

(21) Appl. No.: 12/414,411

(22) Filed: Mar. 30, 2009

(51) Int. Cl. G06Q 30/00; G06F 15/16

(52) U.S. Cl. 705/14; 709/204; 705/26

(57) ABSTRACT

There is a method of referral marketing over a computerized network configured to incentivize participation and thereby enhance the effectiveness thereof; wherein the method includes steps of providing a webpage to sell products/services over a computerized network. The method includes providing a hypertext offering to a shopper, for a referred shopper to view the products/services purchased by the shopper. Then, creating a discount coupon including a discount code for the referred shopper using a merchant module having a hypertext link to the webpage. The method also includes sending an email including the discount coupon to the referred shopper over the computerized network. Then, the method includes creating an incentive coupon including an incentive code for the shopper that referred the referred shopper. In addition, the method may include sending an email including the incentive coupon to the shopper that referred the referred shopper over the computerized network.

### BACKGROUND OF THE INVENTION

1. Field of the Invention

The present invention relates to methods of marketing, specifically to a method of referral marketing over a computerized network.

2. Description of the Related Art

Referral marketing is a method of Internet marketing that relies on gaining new customers by referrals, usually through word of mouth. Many companies obtain over half of their business through word of mouth from satisfied customers and contacts. This method is generally spontaneous and may be achieved by businesses without any form of structured strategy. Referral marketing is a structured and systematic process that maximizes word of mouth potential. Referral marketing seeks to cause customers and contacts to think and talk as much as possible about their supplier, their company, product and service and the value and benefit the supplier brings to them and people they know.

Referral marketing takes word of mouth from the spontaneous situation to a proactive and highly productive solution, where maximum referrals are generated due to professional customer-focused strategies. People, typically users of a get-paid website, are encouraged to refer their friends (or indeed anyone) through a personal referral link, which would look something like: www.getpaidsite.com/?referrer=NAME, where NAME is the username of the referring user. The user then earns an equivalent percentage of what the referral earns.

On the internet there are multiple referral methods. For example posting information on the business on a forum or simply posting to friends in a professional network and social network like Facebook or LinkedIn. Another option is to use web-sites focused on referral tracking and bonus distribution. Some improvements have been made in the field. Examples of references related to the present invention are described below, and the supported teachings of each reference are incorporated by reference herein:

U.S. Pat. No. 6,578,011, issued to Forward, discloses a buyer-seller matching system that uses incentives to verify commissions from matching the buyer with a seller. An item locator system that comprises a repository of information about items for purchase may be provided over a network for users to access information about items for purchase. Along with each item, the system presents an incentive that may be realized if that item is purchased from a designated third party seller. The user then executes the purchase with the seller, who pays the system the agreed upon fee and also issues a certification of purchase to the buyer. The user may then take the certification of purchase back to the central repository to redeem the incentive. The item locator system then checks to verify that it has received a fee or commission from the seller for bringing the seller a buyer of the item. The fee or commission may be based on the price of the item, such as if the item is a new house for sale and the seller is a new house builder.

U.S. Pat. No. 6,029,141, issued to Bezos et al., discloses an Internet-based referral system that enables individuals and other business entities (“associates”) to market products, in return for a commission, that are sold from a merchant's Web site. The system includes automated registration software that runs on the merchant's Web site to allow entities to register as associates. Following registration, the associate sets up a Web site (or other information dissemination system) to distribute hypertextual catalog documents that includes marketing information (product reviews, recommendations, etc.) about selected products of the merchant. In association with each such product, the catalog document includes a hypertextual “referral link” that allows a user (“customer”) to link to the merchant's site and purchase the product. When a customer selects a referral link, the customer's computer transmits unique IDs of the selected product and of the associate to the merchant's site, allowing the merchant to identify the product and the referring associate. If the customer subsequently purchases the product from the merchant's site, a commission is automatically credited to an account of the referring associate. The merchant site also implements an electronic shopping cart that allows the customer to select products from multiple different Web sites, and then perform a single “check out” from the merchant's site.

U.S. Pat. No. 5,537,314, issued to Kanter, discloses a credit accumulation and accessing system for a plurality of sponsoring companies and participants having at each sponsoring company location, a common bus, which communicates with participant data input, performance data input, computer processing, memory, an award output device, and an input/output device. Input/output device may connect to a central control center, and/or a plurality of second sponsoring companies, and/or a plurality of financial institutions, through communication lines. Sponsoring company, participant, and performance data, along with award conversion tables, pyramidal association tables, award applicable merchandise UPC codes, financial-institution-issued lines of credit and computer operational programming, are stored. Under control of the operational program several tasks are accomplished accordingly, including, creating subdirectories for a single participant account so as to selectively associate the single account subdirectories with multiple sponsoring company accounts and deciphering such accordingly at points of sale, calculating, posting, and/or issuing discounts, raffle entries, store-credit returns, points, cash values, bill values, in accordance with performance of participants, while sending results immediately and/or periodically to appropriate destinations, which may include computer memory and/or bank accounts and/or plastic cards on behalf of participants, participant sponsors in a pyramidal-type structure, sponsoring companies, sponsoring companies' sponsors in a pyramidal-type structure, raffle sponsors, and redeemed at appropriate locations which may include, sponsoring company, participant, beneficiary, or financial institution bank accounts, sponsoring company locations, designated sponsoring company award output devices, participants' households, beneficiaries' locations, and cash dispensing machines, and received in the appropriate forms, which may include, designated sponsoring company merchandise, wire transfer, check, cash, coupon, certificate, charge card balance reductions, travel tour, or catalog merchandise.

U.S. Pat. No. 6,980,962, issued to Arganbright et al., discloses a system and method for providing complete electronic commerce (“E-Commerce”) transactions and solutions for a marketing company's products via the World Wide Web, including facilities for signing up new customers and recruiting, training and supporting new Independent Business Owners through an interactive online process. In another aspect, the present invention relates to the combination of a marketing business with a membership buying opportunity using both electronic commerce and face-to-face transactions. The present invention is also directed to a system and method for combining a marketing business with a membership buying opportunity, so that Independent Business Owners participating in the marketing plan can introduce customers to a membership buying opportunity and earn bonuses or commissions based on the purchases by those members, while Members in the buying opportunity can consume products or, at their option, qualify to become Independent Business Owners.

U.S. Pat. No. 7,184,971, issued to Ferber, discloses an invention that makes it easy to collect, manage, and communicate with consumers using e-mail and other forms of push-based messaging as the primary vehicle for communication of marketing content. The software makes it simple to offer bounties or other types of compensation to any participant interested in referring new users to into the system as well as offer a multiple tier referral system so that those participants can refer others as well. The present invention: makes it possible to track the entire path of a communication and all of the actions inside of it for modeling and other analytical purposes; simplifies the process for generating custom marketing communications in large capacity; simplifies the process of enabling the selection, insertion and delivery of marketing communications inside of the main communication layer and enables an administrator to easily administer all aspects of the software from an intuitive web based interface.

The inventions heretofore known suffer from a number of disadvantages which include being limited in application, being limited in versatility, being expensive, being difficult to use, being burdensome, being too complicated, being ineffective, failing to motivate participants, failing to replicate results, failing to replicate positive behavior of customers and contacts, and being inefficient.

What is needed is a method and/or system of referral marketing over a computerized network that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available methods of marketing. Accordingly, the present invention has been developed to provide an effective and efficient referral marketing method.

In one embodiment of the invention, there is a method of referral marketing over a computerized network configured to incentivize participation and thereby enhance the effectiveness thereof; wherein the method may include providing a webpage to sell products/services over a computerized network. The method may also include offering a shopper to exchange an incentive for the shopper providing a referral, the incentive conditional on the referral executing a purchase. Then, the method may include creating a discount coupon including a discount code for the referred shopper using a merchant module having a hypertext link to the webpage. In addition, the method may include sending an email including the discount coupon to the referred shopper over the computerized network

The method may further include providing a webpage associated with the hypertext; wherein the referred shopper may view and purchase products/services over the computerized network. The method may additionally include creating an incentive coupon including an incentive code associated with the shopper that referred the referred shopper. The method may then include sending an email including the incentive coupon to the shopper that referred the referred shopper over the computerized network. Furthermore, the method may include providing a webpage associated with the merchant's products/services over a computerized network, wherein the webpage enables the shopper to use the incentive code to receive a discount on a subsequent purchase of products/services for referring the referred shopper.

In another embodiment of the invention, there is a system of referral marketing over a computerized network configured to incentivize participation and thereby enhance the effectiveness thereof, having a merchant module. The merchant module may include a communication module configured to couple to a computerized network and transfer data through the computerized network. The merchant module may also include a database module in communication with the communication module and configured to store information. The merchant module may further include a control module in communication with the communication module, including a computer interface, and configured to selectably modify configuration information of a module described herein. The control module may also include instructions for configuring the incentive module and configuring the discount module. Furthermore, the control module may include instructions for selectably altering a benefit and an incentive.

In addition, the merchant module may include an incentive module in communication with the communication module and configured to solicit referrals and manage incentive distribution to accounts credited with a successful referral. The incentive module may deliver incentive redemption by email. The incentive module may also provide a plurality of alternatively selectable incentives to accounts credited with a successful referral. Moreover, the incentive module may generate a discount code when a referral is received and passes the discount code to the discount module. The merchant may also include a discount module in communication with the communication module and configured to offer benefits to referred potential purchasers and manage distribution of benefits to referred potential purchasers that execute a purchase. The discount module may offer benefits by email. The discount module may be in communication with the incentive module and wherein the discount module may additionally include instructions for informing the incentive module of a successful purchase by a referred shopper. Furthermore, the merchant module may include a server module in communication with the communication module and configured to manage communications provided by the communication module. The server module may include an email server and a web server in communication with the email server and wherein the email server delivers hypertext links directed to the web server.

In yet another embodiment of the invention, there is a method of referral marketing over a computerized network configured to incentivize participation and thereby enhance the effectiveness thereof. The method may include selling products/services over a computerized network. The method may also include offering to provide an incentive in exchange for a referral that executes a purchase. The method may further include receiving a referral. Then, the method may include storing referral information in a database module. In addition, the method may include offering a benefit to the referral subject through a computerized network. The method may also include receiving a purchase request from the referral subject. Furthermore, the method may include providing the benefit to the referral subject. Moreover, the method may include providing the incentive over a computerized network to a source of the referral.

The method may include the incentive may be subsequent to and conditional on the step of receiving the purchase request from the referral subject. The method may also include offering a benefit may be executed by email. The method may further include generating a unique code associated with the received referral and associating that code to the source of the referral and the referral subject.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a network diagram of a system of referral marketing, according to one embodiment of the invention;

FIG. 2 is a sequence diagram of a method of referral marketing, according to one embodiment of the invention;

FIG. 3 is a module diagram of a system of referral marketing, according to one embodiment of the invention;

FIG. 4 is a prophetic and exemplary screenshot of a promotional message, according to one embodiment of the invention;

FIG. 5 is a prophetic and exemplary screenshot of an incentive reward message, according to one embodiment of the invention;

FIG. 6 is a prophetic and exemplary screenshot of an incentive module in operation, according to one embodiment of the invention;

FIG. 7 is a network diagram of a system of referral marketing, according to one embodiment of the invention;

FIG. 8 illustrates a method of pre-configuring a system of referral marketing, according to one embodiment of the invention; and

FIGS. 9-11 illustrate a method of referral marketing, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

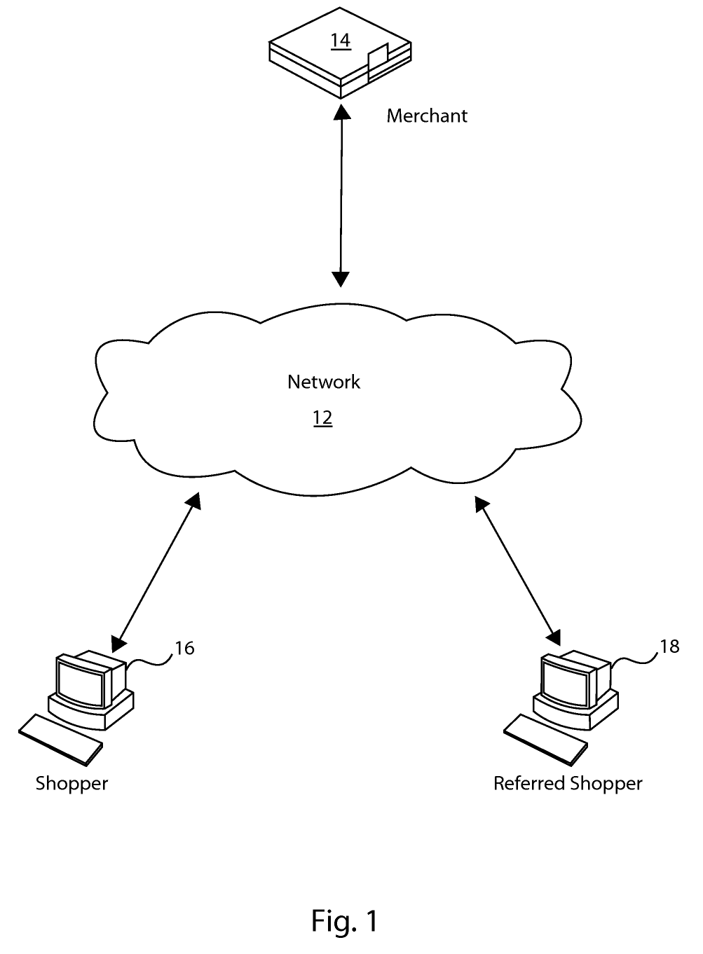

FIG. 1 is a network diagram of a system of referral marketing over a computerized network 10 configured to incentivize participation and thereby enhance the effectiveness thereof. According to one embodiment of the invention, the system includes a computerized network 12 in communication with each of a merchant 14, a shopper 16 and a referred shopper 18. Through the network 12, each of the merchant 14, a shopper 16 and a referred shopper 18, and in particular, their respective devices, may be able to communicate. Accordingly, messages may be sent and received across the network and observed through the devices coupled to the network 12.

The computerized network 12 may be, but not limited to the Internet, an intranet, an electronic communication system connecting a plurality of nodes, a distributed wireless network, and/or etc. Wherein the computerized network 12 is a combination of one or more different networks, the different networks are coupled sufficiently to send and receive the information as indicated in this application. For example, there may be a merchant device with a hard-line connection to the Internet, a shopper using a cell-phone in communication with a cellular system that is in communication with the internet, and a referred shopper having a wireless laptop connected sporadically to a free wireless connection to the Internet and having an email services that caches received emails until a connection is made and the information may be distributed appropriately.

The merchant 14, shopper 16 and referred shopper 18 are entities each having a device or system configured to send and/or receive information over a computerized network 12. These devices may include but are not limited to servers, personal computers, cell-phones, laptops/notebook computers, personal digital assistants, and the like. Accordingly, each of the merchant 14, shopper 16 and referred shopper 18 are enabled to send and receive messages as indicated herein. The terms “merchant” “shopper” and “referred shopper” are not intended to be interpreted as always and only identifying past behavior of the entities/devices involved.

The merchant 14 may represent one or more entities having goods and/or services for sale. The merchant 14 may include one or more devices, modules, or etc. configured to facilitate communication among the parties and/or to increase referral behavior between the shopper and the referred shopper. Accordingly, the merchant 14 and the device(s) and/or system(s) included therein are preconfigured to facilitate and/or incentivize current and/or future referral behavior between the shopper and the referred shopper. One or more of the preconfigured devices and/or systems may be distributed between, among, and/or throughout the network, the shopper, and/or the referred shopper. Accordingly, those involved may be able to send and/or receive, in some cases automatically or otherwise facilitated, information directed to increasing the effectiveness, capacity, efficiency, or occurrence of referral behavior or the benefits thereof.

In particular, some or all of the following messages and/or actions may be taken over the illustrated system in one or more embodiments of the invention. The merchant 14 modifies the contents and design of the website/webpage, in addition to the presentation of the products/services over the computerized network 12. The shopper 16 views the merchant's website/webpage and purchases product/services from the merchant 14. The shopper 16 refers a referred shopper 18 to view or purchase the products/services from the merchant 14, over the computerized network 12.

In operation of one embodiment of the invention, a shopper views a merchant's website over a computerized network. During the purchasing process the shopper may choose to refer another shopper, to view the products/services that the original shopper purchased. The shopper clicks on a link that instructs the shopper to enter the shopper's contact information and the referred shopper's contact information. The merchant then sends an email including a discount coupon to the referred shopper; wherein the referred shopper opens the email and selects a link to the merchant's webpage, including the products/services purchased from the original shopper. The referred shopper purchases the products/services at a discounted price by using the discount coupon. Upon completion of the purchase of products/services by the referred shopper, the merchant sends an email including an incentive reward coupon to the original shopper. The original shopper may use the coupon on the next subsequent purchase from the merchant's website over the computerized network.

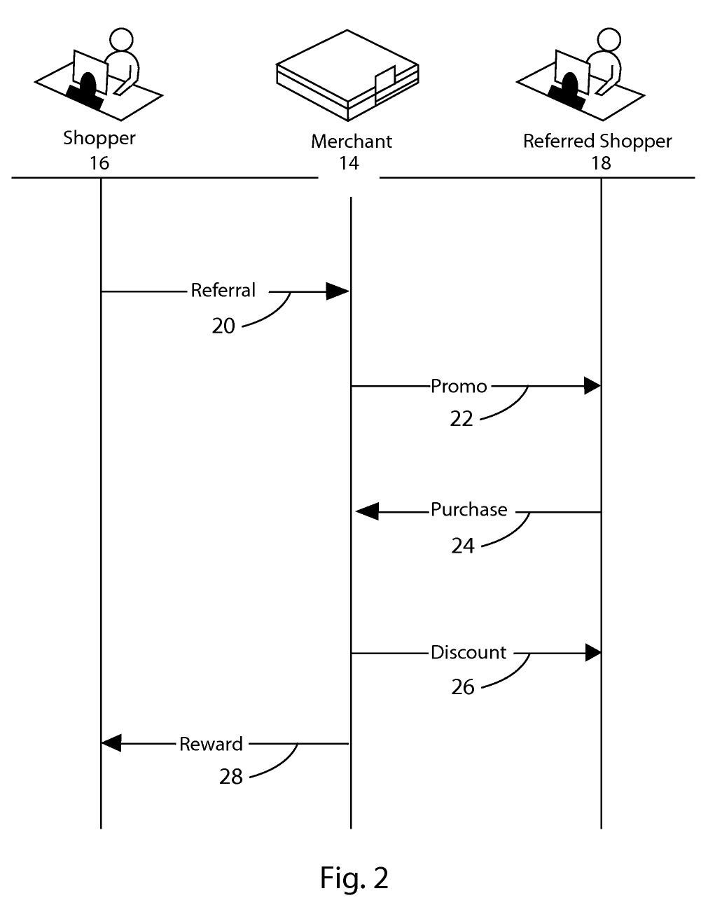

FIG. 2 is a sequence diagram of a method of referral marketing over a computerized network, according to one embodiment of the invention. The illustrated sequence includes a shopper 16, a merchant 14 and a referred shopper 18, each connected over a computerized network such that each is able to send information to others as indicated. In particular, the shopper 16 and merchant are able to communicate and the merchant 14 and referred shopper 18 are able to communicate. In the illustrated method, a shopper 16 sends a referral 20 to a merchant 14 who provides a promo 22 to a referred shopper 18. The referred shopper 18 makes a purchase 24 related to the promo 22 and receives a discount 26 from the merchant 14. The merchant then provides a reward 28 to the shopper 16. The order and/or timing of the steps may vary from the illustrated sequence and there may be additional steps and/or parties involved.

In the illustrated method, the shopper 16 sends referral information 20 to the merchant 14. Such may follow and/or coincide with the shopper viewing the merchant's website/webpage and purchasing product/services. The referral 20 may include contact information for the referred shopper 18, such as but not limited to an email address, and identifying information for the shopper 16, such as but not limited to a name, account number, address, and the like. The referral 20 may contain additional information such as but not limited to preference information for the shopper and/or the referred shopper regarding preferred goods/services, modes of communication, and the like. Additional referral information may also include historical and/or statistical information regarding the shopper and/or the referred shopper that may be stored with the shopper 16 and/or index information referencing similar information that may be stored elsewhere such as but not limited to the merchant 14. In one embodiment, the referral 20 is provided through an internet browser through fields that may receive information input from the shopper.

In the illustrated method, the merchant 14 provides a promo 22 to a referred shopper 18 based on information from the referral 20. The promo 22 includes information sufficient to enable the referred shopper 18 to initiate a purchase or otherwise interact with the merchant in a favorable manner. In one embodiment, the promo is an email that includes a hypertext link to a web page where the referred shopper may initiate a purchase order. The promo may also include details regarding any discount or other incentive included with the intention of inducing, persuading, or otherwise increasing the likelihood and/or frequency of a positive interaction between the merchant and the referred shopper. Accordingly, when the promo is received, the referred shopper is likely to purchase goods or services from the merchant.

In the illustrated sequence, the referred shopper 18 purchases 24 goods and/or services from the merchant 14. Such may be effectuated by the referred shopper placing an order over a computerized network (example: ordering online with a credit card), by phone, by mail, or through another mode of communication. Such may include exchanging consideration (cash, credit, etc.). In another embodiment, the referred shopper may simply send an affirmative reply or may neglect to send a refusal, such as in the case of product delivered and associated with a billing statement or invoice.

In the illustrated sequence, the merchant 14 provides a discount 26 to the referred shopper 18. The discount 26 may result in any benefit to the referred shopper and may include, but is not limited to a reduction in charge for goods and services from a listed price, a rebate, additional goods and services at a reduced or zero charge, and the like. The discount may be delivered over the computerized network or through some other means, such as but not limited to mail, phone or the like. The discount 26 may include information configured to facilitate receipt of the benefit, such as a discount coupon or code.

In the illustrated sequence, the merchant 14 provides a reward 28 to the shopper 16. The reward 28 may result in a payment, delivery of goods and/or services, a discount in future goods and/or services, a rebate, or other benefit to the shopper. The reward 28 may include information configured to facilitate receipt of the benefit of the reward 28 such as a redemption coupon, a link to a website where a reward may be selected and automatically shipped to the address of the shopper's account with the merchant, and the like. The reward 28 may be sent over the computerized network and/or may be sent over other means of communication and/or delivery such as through the mail or phone. The reward 28 may include a reward coupon including an incentive code for the shopper 16 that referred the referred shopper 18.

In operation of one embodiment of the invention, a shopper views a merchant's website over a computerized network. The shopper chooses to refer another shopper to view the products/services that the original shopper purchased. The shopper clicks on a link that instructs the shopper to enter the shopper's contact information and the referred shopper's contact information. The merchant then sends an email including a discount coupon to the referred shopper; wherein the referred shopper opens the email and selects a link to the merchant's webpage including the products/services purchased from the original shopper. The referred shopper purchases the products/services at a discounted price by using the discount coupon provided in the email. Upon completion of the purchase of products/services by the referred shopper, the merchant sends an email including an incentive reward coupon to the original shopper. The original shopper uses the reward coupon on the next subsequent purchase from the merchant's website over the computerized network.

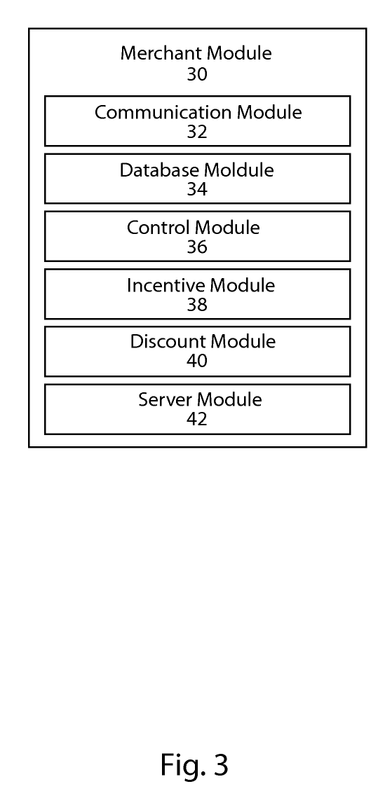

FIG. 3 is a module diagram of a merchant module of a system of referral marketing, according to one embodiment of the invention. The illustrated merchant module includes a communication module 32, a database module 34, a control module 36, an incentive module 38, a discount module 40 and a server module 42. The illustrated modules are in sufficient communication with other modules within the merchant module to accomplish the results described herein. Such communication may be over a network, through shared data storage, and the like. The modules may be embodied in code operating on one or more computers or computer systems and/or in hardware configured to operate as described herein. Each of the modules may be configured to operate automatically once configured and to share information as required to operate automatically. Accordingly, the merchant module may function to automate one or more steps of a method of referral marketing. A merchant module may be distributed over a plurality of devices and may interact with or incorporate one or more devices under the control or ownership of other parties, including but not limited to a shopper and/or a referred shopper.

The merchant module 30 includes a communication module 32; wherein the communication module 32 is configured to couple the merchant module 30 to a computerized network. The communication module 32 transfers data, through the computerized network, to potential buyers of products/services provided by the merchant, on a website/webpage. The merchant module 30 also includes a database module 34; wherein the database module 34 is configured to store and organize information such as but not limited to shopper and referred shopper information, including but not limited to: information described elsewhere in this application and/or previous purchases, type of payment, types of purchases, etc. In addition, the merchant module 30 includes a control module 36; wherein the control module 36 enables the merchant to modify aspects of the merchant module 30 such as but not limited to configuring other modules and products/services presented and displayed on the website/webpage and other merchant data including product/services price.

In addition, the merchant module 30 further includes an incentive module 38; wherein the incentive module 38 enables a merchant to modify an incentive reward coupon for a shopper that referred another shopper to purchase products/services from the merchant. The merchant may modify the amount of incentive reward, the time period to redeem the reward, and other aspects of the incentive reward. Furthermore, the merchant module 30 includes a discount module 40; wherein the discount module 40 is configured to modify a discount coupon to the referred shopper to purchase products/services purchased by the original shopper. The merchant may modify the amount of the discount, the time period to redeem the discount, and other aspects of the discount coupon. The merchant module 30 also includes a server module 42; wherein the server module 42 is configured to manage communication over the computerized network to the shopper and referred shopper over the computerized network. Such may be embodied as a mail server or other device/software configured to send, receive, and/or manage emails.

In operation of one embodiment of the invention, a merchant using the control module of the merchant module to modify the contents and design of the merchant's website/webpage. The merchant also uses the incentive module and the discount module to modify the incentive reward coupon sent to the shopper that referred another shopper to purchase products/services from the merchant and the discount coupon sent to the referred shopper to purchase products/services purchased from the original shopper. The database module stores data regarding the merchant, shoppers, and referred shoppers; and the server module sends the data to the shoppers and referred shoppers.

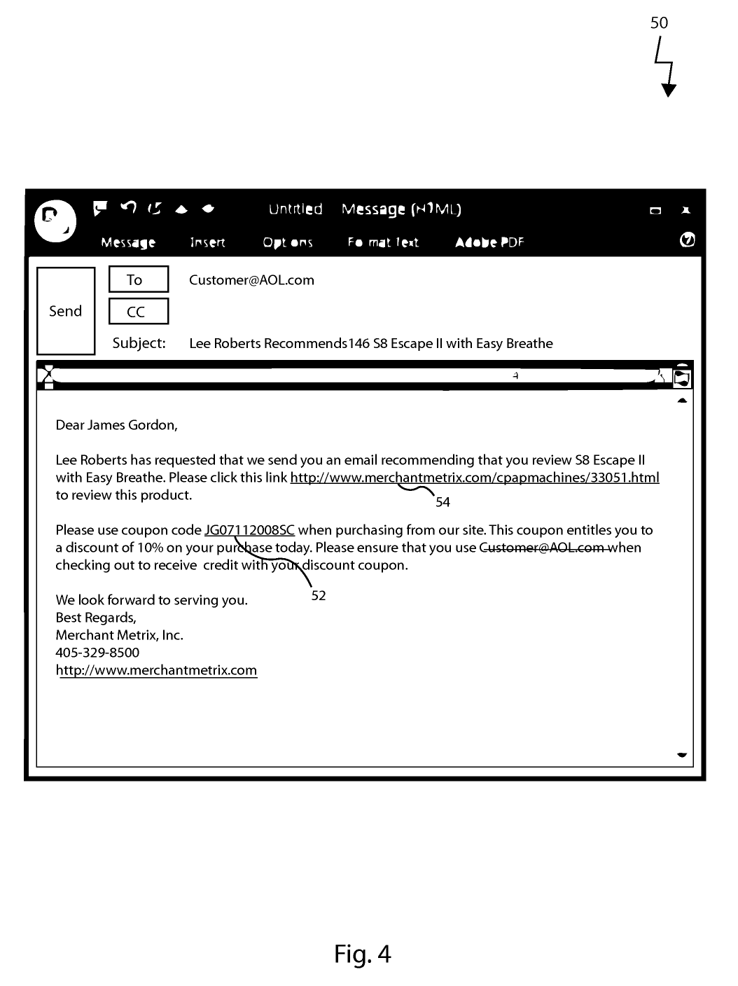

FIG. 4 is a prophetic and exemplary screenshot of a promotional message 50, according to one embodiment of the invention wherein the promotional message 50 is sent to a referred shopper from the merchant over a computerized network. The promotional message 50 includes a hypertext link 54 offering the referred shopper to review products/services purchased from the original shopper. The promotional message includes a discount code 52 for the referred shopper to purchase products/services from the merchant over the computerized network. The promotional message 50 also includes an email code 56; wherein the email code 56 is needed to complete the discounted purchase of the products/services.

In operation of one embodiment of the invention, a shopper selects a hypertext offering to refer another shopper to purchase products/services from a merchant over a computerized network. The shopper enters the shopper's contact information and the contact information of the shopper they are referring through the computerized network to the merchant. The merchant creates a promotional message for the referred shopper and sends the message over the computerized network. The referred shopper may use the discount code to purchase products/services, that the original shopper purchased, over the computerized network

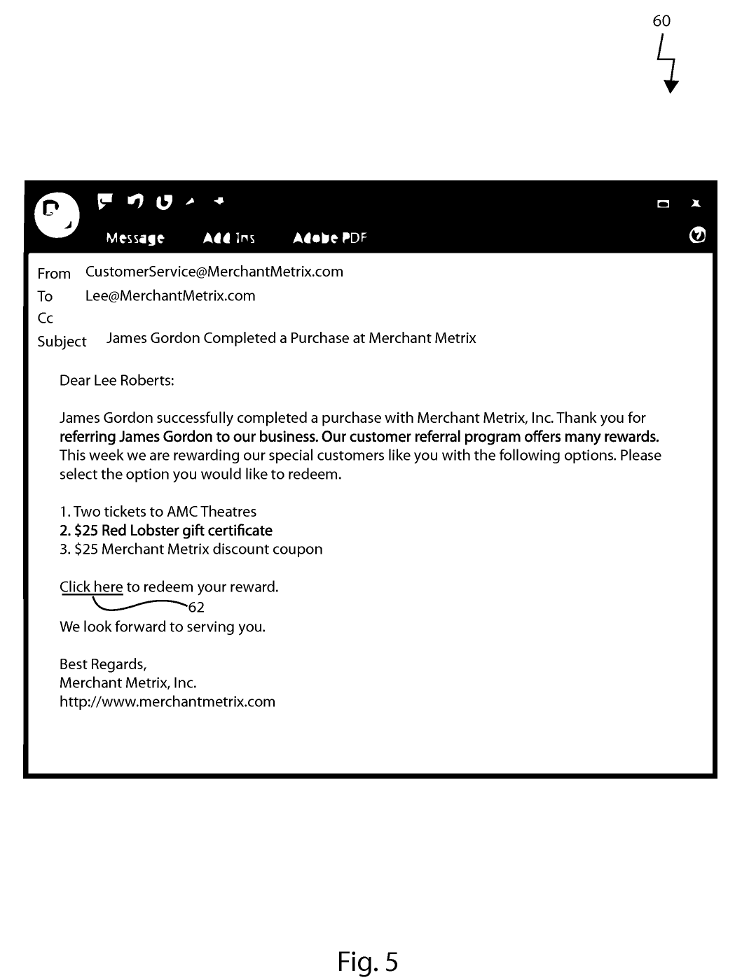

FIG. 5 is a prophetic and exemplary screenshot of an incentive reward message, according to one embodiment of the invention, wherein the incentive reward message includes a referral reward including a hypertext link 62; wherein the shopper may redeem rewards selected from a group of rewards the shopper may choose from. In addition, the incentive reward message 60 may include an incentive code for the shopper that referred the referred shopper that purchased products/service from the merchant over the computerized network. The incentive code may be used on the next subsequent purchase of products/services from the merchant over the computerized network. Furthermore, the incentive reward message 60 is sent to the referring shopper upon completion of the purchase of products/services by the referred shopper from the merchant over the computerized network.

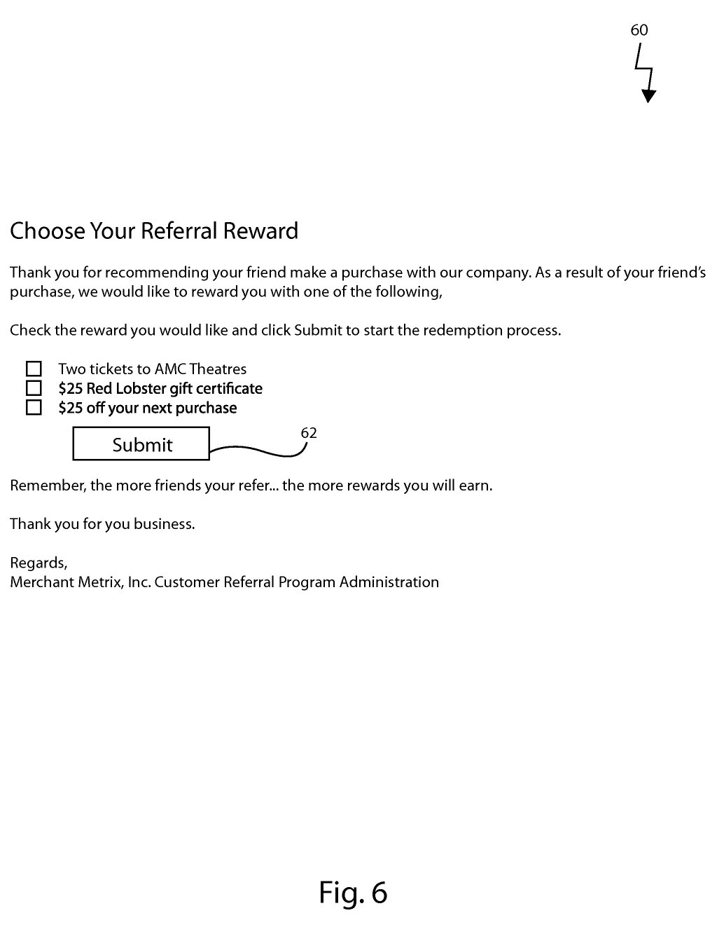

FIG. 6 is a prophetic and exemplary screenshot of an incentive module 38 in operation, according to one embodiment of the invention, wherein the incentive module 38 includes sending an incentive reward message to a referring shopper. The incentive reward message includes a referral reward including a hypertext link 62; wherein the shopper may redeem rewards selected from a group of rewards the shopper may choose from. In addition, the incentive reward message may include an incentive code for the shopper that referred the referred shopper that purchased products/service from the merchant over the computerized network. The incentive code may be used on the next subsequent purchase of products/services from the merchant over the computerized network. Furthermore, the incentive reward message is sent to the referring shopper upon completion of the purchase of products/services by the referred shopper from the merchant over the computerized network.

In operation of one embodiment of the invention, a referred shopper completes the purchase of products/services from the merchant over the computerized network. The merchant then creates an incentive reward message and sends an email including the incentive reward message to the original shopper. The shopper receives the email and may select a reward from the group of rewards and then, redeems the reward accordingly. In addition, the incentive reward message may include an incentive code, wherein the shopper may use the incentive code on a subsequent purchase of products/services from the merchant over the computerized network.

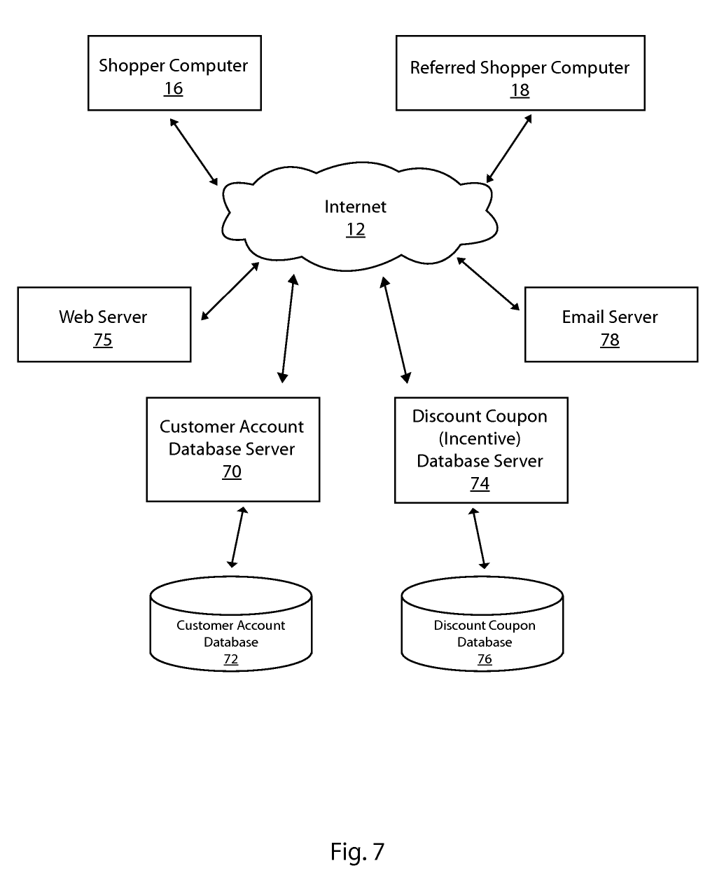

FIG. 7 is a network diagram of a system of referral marketing over a computerized network, according to one embodiment of the invention, wherein the system is configured to incentivize participation and thereby enhance the effectiveness thereof. The system includes a shopper 16, in communication with a web server 75, over the internet 12, wherein the shopper 16 views a merchant's website/webpage and purchases product/services from the merchant from a computer. The shopper 16 may select a hypertext offering to send a promotional message to a referred shopper 18 to view or purchase the products/services purchased by the shopper 16, over the internet 12. The shopper 16 enters the shopper's contact information and the referred shopper's contact information; wherein the merchant references a customer account database server 70. The customer account database server 70 references a customer account database 72 and ensures that the shopper has a customer account with the merchant, which is associated with the website/website. The merchant then creates a discount coupon; wherein a discount coupon database server 74 references a discount coupon database 76 and configures a discount coupon for the referred shopper 18. Then an email server 78 sends an email including the discount coupon to the referred shopper 18 over the internet 12.

Furthermore, the system includes the referred shopper 18 viewing the products/services purchased by the shopper 16 with a computer, over the internet 12; wherein the referred shopper 18 may purchase product/services from the merchant. Upon completion of the purchase of products/services from the referred shopper 18; the merchant references the discount coupon database and creates an incentive coupon including an incentive code for the shopper 16 that referred the referred shopper 18. The email server 78 then sends an email including the incentive coupon to the shopper 16 that referred the referred shopper 18 over the internet 12; wherein the shopper 16 receives an incentive reward for the next subsequent purchase from the merchant.

In operation of one embodiment of the invention, a shopper views a merchant's website over an internet with a computer. During the purchasing process the shopper may choose to refer another shopper to view the products/services that the original shopper purchased. The shopper clicks on a link that instructs the shopper to enter the shopper's contact information and the referred shopper's contact information. The merchant then sends an email including a discount coupon to the referred shopper; wherein the referred shopper opens the email and selects a link to the merchant's webpage, including the products/services purchased from the original shopper. The referred shopper purchases the products/services at a discounted price by using the discount coupon. Upon completion of the purchase of products/services by the referred shopper, the merchant sends an email including an incentive reward coupon to the original shopper. The original shopper may use the coupon on the next subsequent purchase from the merchant's website over the computerized network.

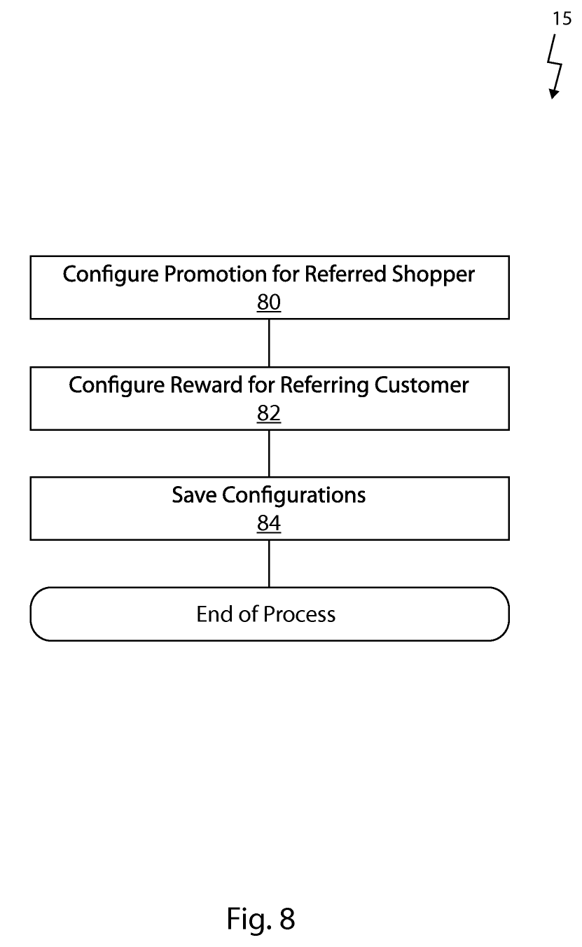

FIG. 8 illustrates a method of pre-configuring a system of referral marketing, according to one embodiment of the invention; wherein the method 15 includes a merchant configuring an promotional discount for a referred shopper 80; wherein the merchant may configure the discount incentive reward including the discount incentive coupon and discount incentive code to be sent to the referred shopper. In addition, the method 15 also includes a merchant configuring the incentive for the referring customer 82; wherein the merchant may configure the incentive reward including the incentive coupon and incentive code to be sent to the referred shopper. The method 15 then includes saving the configurations for the incentive reward and the promotional discount 84.

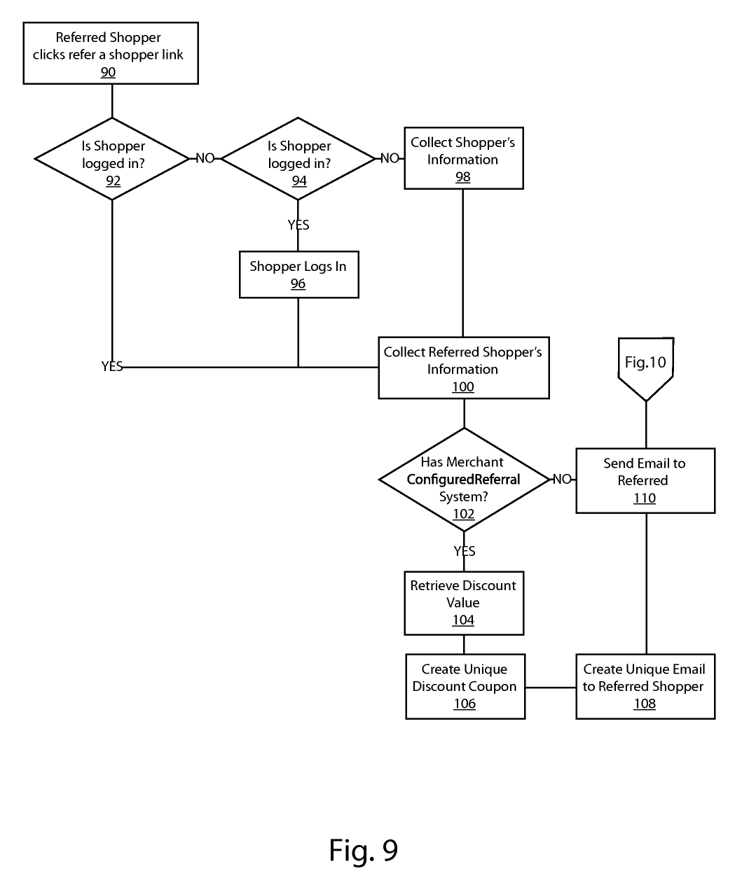

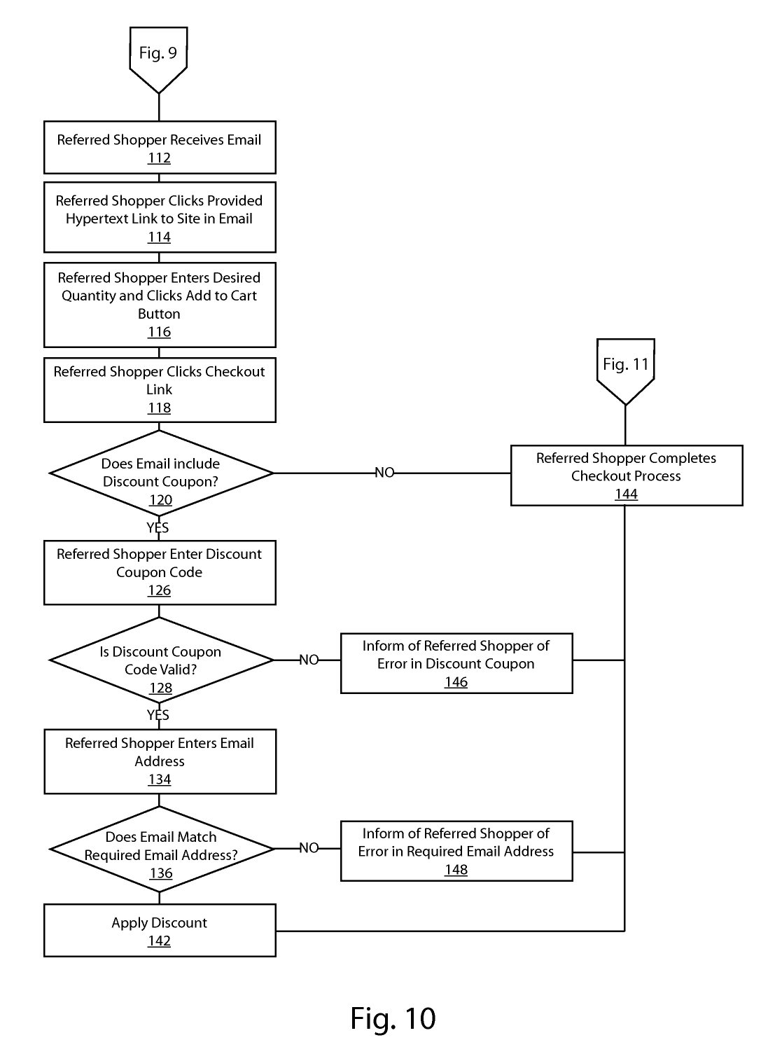

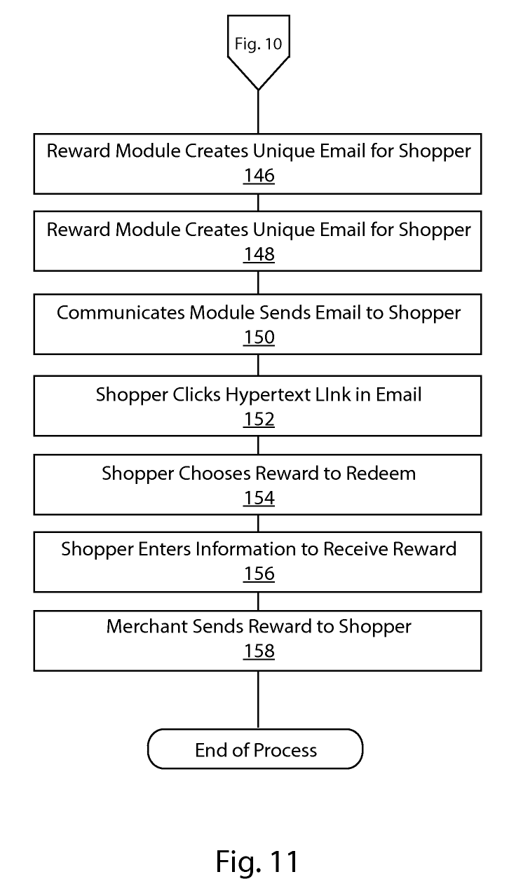

FIGS. 9-11 illustrate a method of referral marketing over a computerized network, according to one embodiment of the invention; wherein the method 25 is configured to incentivize participation and thereby enhance the effectiveness thereof. In the illustrated method, interactions by the shopper and referred shopper are effectuated as a result of steps taken by a merchant module.

The method 25 includes a referring shopper clicking on refer a shopper link 90. The method 25 then includes the merchant module referencing if the shopper is logged in 92, if the shopper is logged in 91 then the shopper is asked does the shopper have an account 94, if the shopper selects no, then the merchant module collects the shopper's information 98. If the shopper is logged in 93 or logs in after asked does the shopper have an account 95 the method 25 continues to wherein the merchant module collects the referred shopper's contact information. Then, the method 25 includes referencing the merchant module if the merchant has configured the referral system 102. If yes, the merchant module retrieves the discount value 104 and creates an unique discount coupon 106. The merchant module then creates a unique email to the referred shopper including the unique discount coupon. The method 25 also includes sending the email to the referred shopper 110. If the merchant has not configured the referral system then the merchant module sends the email to the referred shopper 101.

In addition, the method 25 includes the referred shopper receiving the email including the discount coupon 112. The method 25 also includes the referred shopper clicking on the provided hypertext link to the webpage/website in the email 114. Then, the method 25 includes the referred shopper entering the desired quantity and clicks on the add to cart action 116. The method 25 further includes the referred shopper clicking the checkout link 118. The method 25 then references if the email included a discount coupon 120. If yes, then the referred shopper enters the discount coupon code from the email 126. The method 25 then includes referencing if the discount coupon code is valid 128; if yes, the referred shopper enters the shopper's email address 134. The method 25 then references if the email matches the required email address 136; if yes, then the discount is applied 142. If the discount coupon code is not valid 130 or if the email does not match the required email address 138 the referred shopper will be informed of the error 146, 148. The method 25 then includes the shopper completing the checkout process 144.

Furthermore, the method 25 includes the reward module creating a unique coupon for a shopper 146. Then the method 25 includes a reward module creating a unique email including the unique coupon for the shopper 148. The method 25 also includes a communications module sending the unique email to the shopper 150. The method 25 then includes the shopper clicking on the hypertext link in the unique email 152. And, the shopper then chooses a reward to redeem 154. Moreover, the method 25 includes the shopper enters the information to receive the reward 156. The method 25 further includes the merchant sending the reward to the shopper 158.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate a single referred shopper, one skilled in the art would appreciate that the method of referral marketing may include a merchant module configured to respond to a plurality of shoppers and still perform its intended function.

Additionally, although the figures illustrate specific ordering of steps, it is understood that one skilled in the art may reorder one or more steps described herein and receive substantially similar results for some sets of reordering.

More, while specific implementations, devices, software and the like are described herein, it is understood that there are a great plurality of such available and more available as time passes and one skilled in the art would recognize that they may be utilized in a system or method of referral marketing as described herein.

Finally, while specific groupings of features, functions, structures, steps, devices, and the like are described herein in conjunction, it is understood that each of the features, functions, structures, steps, and devices described herein may be utilized together or separately, individually or collectively in one or more embodiments of the invention as claimed.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A method of referral marketing over a computerized network configured to incentivize participation and thereby enhance the effectiveness thereof, comprising the steps of:
a) providing a webpage to sell products/services over a computerized network;
b) offering a shopper to exchange an incentive for the shopper providing a referral, the incentive conditional on the referral executing a purchase;
c) creating a discount coupon including a discount code for the referred shopper using a merchant module having a hypertext link to the webpage;
d) sending an email including the discount coupon to the referred shopper over the computerized network;
e) providing a webpage associated with the hypertext; wherein the referred shopper may view and purchase products/services over the computerized network;
f) creating an incentive coupon including an incentive code associated with the shopper that referred the referred shopper;
g) sending an email including the incentive coupon to the shopper that referred the referred shopper over the computerized network; and
h) providing a webpage associated with the merchant's products/services over a g computerized network, wherein the webpage enables the shopper to use the incentive code to receive a discount on a subsequent purchase of products/services for referring the referred shopper.

2. The method of claim 1, further including receiving the shopper and the referred shopper's contact information from the hypertext offering.

3. The method of claim 1, further including referencing a customer database module for the shopper contact information to determine if the shopper has a customer account.

4. The method of claim 1, further including providing a webpage associated with the hypertext.

5. The method of claim 1, further including modifying a discount module and an incentive module of a merchant module to set the discount codes and incentive codes.

6. The method of claim 1, further including modifying the products/services displayed on the web page over the computerized network.

7. A system of referral marketing over a computerized network configured to incentivize participation and thereby enhance the effectiveness thereof, having a merchant module, comprising:
a) a communication module configured to couple to a computerized network and transfer data through the computerized network;
b) a database module in communication with the communication module and configured to store information;
c) a control module in communication with the communication module, including a computer interface, and configured to selectably modify configuration information of a module described herein;
d) an incentive module in communication with the communication module and configured to solicit referrals and manage incentive distribution to accounts credited with a successful referral;
e) a discount module in communication with the communication module and configured to offer benefits to referred potential purchasers and manage distribution of benefits to referred potential purchasers that execute a purchase; and
f) a server module in communication with the communication module and configured to manage communications provided by the communication module.

8. The system of claim 7, wherein the server module is an email server.

9. The system of claim 7, wherein the discount module offers benefits by email.

10. The system of claim 7, wherein the incentive module delivers incentive redemption by email.

11. The system of claim 7, wherein the incentive module provides a plurality of alternatively selectable incentives to accounts credited with a successful referral.

12. The system of claim 7, wherein the control module includes instructions for configuring the incentive module and configuring the discount module.

13. The system of claim 12, wherein the control module includes instructions for selectably altering a benefit and an incentive.

14. The system of claim 7, wherein the incentive module generates a discount code when a referral is received and passes the discount code to the discount module.

15. The system of claim 7, wherein the discount module is in communication with the incentive module and wherein the discount module includes instructions for informing the incentive module of a successful purchase by a referred shopper.

16. The system of claim 7 wherein the server module includes an email server and a web server in communication with the email server and wherein the email server delivers hypertext links directed to the web server.

17. A method of referral marketing over a computerized network configured to incentivize participation and thereby enhance the effectiveness thereof,
comprising the steps of:
a) selling products/services over a computerized network;
b) offering to provide an incentive in exchange for a referral that executes a purchase;
e) receiving a referral;
f) storing referral information in a database module;
g) offering a benefit to the referral subject through a computerized network;
h) receiving a purchase request from the referral subject;
i) providing the benefit to the referral subject; and
j) providing the incentive over a computerized network to a source of the referral.

18. The method of claim 17, wherein the step of providing the incentive is subsequent to and conditional on the step of receiving the purchase request from the referral subject.

19. The method of claim 18, wherein the step of offering a benefit is executed by email.

20. The method of claim 19, further comprising generating a unique code associated with the received referral and associating that code to the source of the referral and the referral subject.
